(19) United States
(12) Patent Application Publication
(10) Pub. No.: US 2003/0113074 A1
(43) Pub. Date: Jun. 19, 2003

(54) Method of packaging a photonic component and package

(76) Inventors: Michael Kohlstadt, San Jose, CA (US); Vladmir Vaganov, Los Gatos, CA (US); Sebastiaan In?apos;t Hout, San Jose, CA (US)

Correspondence Address: PATRICK REILLY, MEGASENSE, INC., 1215 BORDEAUX DRIVE, SUNNYVALE, CA, 94089, US

(21) Appl. No.: 10/022,705

(22) Filed: Dec. 14, 2001

(51) Int. Cl. G02B 6/42

(52) U.S. Cl. 385/92; 385/88

(57) ABSTRACT

A method of packaging a photonic component and a photonic component package are provided. The package comprises a package body, a package lid, and at least two parallel, or dual inline, sets of leads. A semiconductor die is attached to and located within a cavity of the package. The semiconductor die may be a MEMS device and include a movable mirror. The package has a through hole that enables light transmission to and from the die through a photonic inlet side of the package body. The package is a low cost part with lead sets attached on at least two lead sides. The lead sides may be planar and parallel to each other, and both lead sides may substantially orthogonal to the photonic inlet side.

### FIELD OF THE INVENTION

The present invention relates to photonic component packages, and more particularly to photonic component packages fabricated to be reduced both in size and in manufacturing complexity.

### BACKGROUND OF THE INVENTION

Photonic components are of increased benefit when reduced in size and cost. In particular, the need to couple or attach photonic elements, such as optical fibers, to optical or photonic devices within optical switching banks creates needs in the art for improvement in the design of photonic component packages.

Kato, et al., in “Optical module, method for manufacturing optical module and optical communication apparatus”, U.S. Pat. No. 6,282,352 (Aug. 28, 2001) disclose a method to form an optical module with a plastic package by molding resin around an optical device and an optical fiber. Kato et al. provide a package having high rigidity and low thermal expansion properties. But the disclosure of Kato et al. fails to consider or provide optional orientations for insertion of the package into a larger system. Kato et al. does not address the advantages of installing the package onto a printed circuit board after high temperature manufacturing steps of the printed circuit board are completed.

Iida et al. disclose, in U.S. Pat. No. 6,186,673, “Package for optical semiconductor module,” Feb. 13, 2001, an improvement in mounting an optical semiconductor module onto a printed circuit board. The improvement of Iida et al. enables a system designer to orient the optical module in a range of orientation angles relative to a high frequency circuit board. Iida et al. does not enable the low cost application of conventional and low cost package manufacturing methods and suitable materials known in the art, such as ceramic or plastic.

Hoang-Phong La discloses, in International Patent Application (PCT) No. WO 00/60673 (Publication Date: 12 Oct. 2000) entitled “An electro-optical package for reducing parasitic effects”, a package design that allows photonic and electrical signals to be received processed, and responded to with an electrical or a photonic resultant signal. La teaches that his invention can be embodied in a standard and low cost package type and style. Yet La's work is limited to the provision of a device that accepts and emits electrical and photonic signals via a plurality of electricity-to-light and light-to-electricity converters and wherein all of the converters are aligned along the same side of a substrate. La fails to provide or consider a generally applicable package or packaging technique that enables a coupling of a photonic element, e.g., an optical fiber, or a collimator, with a MEMS or semiconductor device and within or via a low cost and standard package size and type.

There is, therefore, a long felt need to provide a package for a photonic component that allows for employing low cost manufacturing techniques and wherein the package may be attached to a socket, a printed circuit board or other appropriate systems or modules known in the art. Module and electronic module denote herein any suitable socket, printed circuit board, system, subsystem or configuration known in the art and suitable for interaction or coupling with a photonic component.

### OBJECTS OF THE INVENTION

It is an object of the present invention to provide a package for a photonic component.

It is another object of certain preferred embodiments of the present invention to provide a packaging method for fabricating photonic components.

It is yet another object of certain preferred embodiments of the present invention to provide a package that partially or entirely encloses a semiconductor die, such as a photonic or optical integrated circuit die or a micro-electromechanical system die.

It is an object of yet other certain alternate preferred embodiments of the present invention to provide a photonic component that comprises a low cost package, the package substantially complying with a suitable semiconductor industry package standard known in the art.

It is an object of certain still other preferred embodiments of the present invention to provide a photonic component with die attachment performed by certain suitable semiconductor industry standard die attach equipment.

It is an object of certain yet other alternate preferred embodiments of the present invention to provide a method of packaging a photonic component having wire bonds formed by certain suitable semiconductor industry standard wire bonding equipment.

It is an object of certain even other alternate preferred embodiments of the present invention to provide a method of packaging photonic components by certain suitable semiconductor industry standard packaging equipment.

It is an object of certain yet other alternate preferred embodiments of the present invention to provide a method of lid attachment of photonic component packages by certain suitable semiconductor industry lid attach equipment.

It is an object of certain other alternate preferred embodiments of the present invention to provide a method of marking of photonic component packages by certain suitable semiconductor industry marking equipment.

It is an object of certain still other alternate preferred embodiments of the present invention to provide optical devices at least partially testable by certain suitable semiconductor industry standard test equipment.

It is an object of certain yet other alternate preferred embodiments of the present invention to provide optical devices mounted onto printed circuit boards by certain suitable semiconductor industry standard mounting equipment.

### SUMMARY OF THE INVENTION

It is an object of the present invention to provide a method of packaging a photonic component. It is another object of the present invention to provide a package for a photonic component that enables (1) an optical coupling of a photonic element and a semiconductor die, and (2) electrical communications between the semiconductor die and an electronic circuit, module, subsystem or system. The photonic component may be a variable optical attenuator (“VOA”), an optical switch, an optical filter, a multiplexer, a demultiplexer, an add-drop optical signal filter, or other suitable optical or photonic device or circuit known in the art. The preferred embodiment, or invented package, is a low cost package that includes a package body having a cavity, a photonic inlet side, and at least two lead sides. A micro-electro-mechanical system die, or MEMS die, having a movable mirror is attached within the cavity and positioned to receive light through, and reflect or transmit light through, a through hole of the package. The term light transmission is defined herein to include reflection, emission, generation, and other suitable methods of sourcing and/or propagating light energy from one location to another location. In the preferred embodiment the MEMS die includes a semiconductor material section, or semiconductor plate, that has a first side and a second opposite side. The first side and the second opposite side are substantially planar and parallel. Electrical contact pads are located on the first side and a movable mirror is coupled to the second opposite side. The package through hole permits access by light from the photonic element side to and from the movable mirror. The through hole extends from the photonic inlet side, or photonic inlet side, and to the cavity. A package lid substantially covers a cavity aperture of a cavity side of the package, whereby the MEMS die is essentially enclosed within the package. Two sets of leads are attached to and extend from two individual lead sides of the package. The lead sets are both attached along the lead sides within a standard dual inline pattern. The leads are electrically coupled with the MEMS die. Electrical power, control and communications signals pass to and from an electronics module or system and to the MEMS die via the leads. The position of the mirror is controlled or affected by the control signals sent to the MEMS die via the leads.

In the invented package a photonic inlet may be mechanically attached to the photonic inlet side of the package. The lead sides of the invented package lie in substantially parallel planes. The photonic inlet side lies in a plane that is substantially orthogonal to both the lead sides, whereby the photonic inlet side is located at right angles to each lead side. A photonic element may be attached to or coupled with the photonic inlet. The photonic inlet and the through hole allow or enable, in various alternate preferred embodiments of the present invention, light to travel bi-directionally to and from the cavity or a MEMS die and the photonic element, or in only one direction to or from the cavity or MEMS die and the photonic element. Alternatively or additionally, a collimator may be attached to the photonic inlet, and one optical fiber and one photonic element may be attached to the collimator. The optical fiber and the photonic element may be positioned relative to the mirror of the MEMS die to allow the mirror to receive from and/or reflect light between the optical fiber and the photonic element.

A second preferred embodiment, or an invented VOA package, provides a package that optically couples a photonic MEMS die and at least two optical fibers. The photonic MEMS die is enclosed within the package body and lid, and the at least two optical fibers are coupled with the photonic inlet via a dual fiber or multi-fiber collimator, as appropriate. The lid and package body of the invented VOA package encloses the MEMS die. The MEMS die is attached to the package body using suitable standard die attach equipment and techniques known in the art. The MEMS die is wire bonded to wire bond pads located in the package. The wire bonding is accomplished with standard wire bonding equipment and applying a suitable wire bonding technique known in the art. The wire bond pads electrically are connected with the leads via traces.

The invented VOA package is designed and sized in conformance with one or more standard semiconductor industry materials, sizing and design standards such that the invented VOA package may be formed, fabricated, assembled, wire bonded, packaged, tested and attached to the PC board with suitable semiconductor industry standard materials, equipment and/or methods. The lid is attached to the package body with standard semiconductor industry lid attach equipment. The invented VOA package is marked with standard semiconductor industry marking equipment. Various preferred embodiments of the package may comprise suitable plastic, metallo-ceramic, or metal-glass, or other suitable materials, known in the art.

Certain alternate preferred embodiments of the method of the present invention can optionally enable the assembly of a photonic component that may be assembled with suitable clean room compatible testing and fabrication equipment known in the art. The range of meaning of the term fabrication includes herein suitable processes and process steps known in the art of assembling, wire bonding, trimming, sealing, die attaching, molding, forming, mounting, packaging, marking, and manufacturing photonic components and electrical systems, subsystems, circuits and modules. The invented VOA package may be mounted onto an electrical circuit, a PC board, a module, a system, a subsystem, or a socket and by using suitable standard device or component mounting equipment and techniques known in the art.

Certain alternate preferred embodiments of the present invention include varieties of numbers of leads in each set, from two to twelve, to larger and much larger lead counts. The leads may be attached in various linear and non-linear patterns to one or more sides of the package. The leads may be arranged and shaped to meet an industry packaging standard and optionally to fit into a standard or non-standard socket.

In certain still alternate preferred embodiments of the present invention the photonic element is optically coupled and optionally mechanically attached to the package, wherein the photonic element is selected from the group consisting of a wave guide, a planar wave guide, a photonic crystal wave guide, a diffraction wave guide grating, an optical fiber, a collimator, a lens, a diffractive lens, an optical lens, a spherical lens, an aspherical lens, a ball lens, a GRIN lens, a C-lens, a lens system, a mirror, a flat mirror, a shaped mirror, a diffractive mirror, a grating plate or plates, a laser, a modulator, a photodiode, a VCSEL, and a prism.

The above summary of the present invention is not intended to describe each illustrated embodiment or every implementation of the present invention. The figures and the detailed description which follow more particularly exemplify these embodiments. Other objects, features, and advantages of the present invention will be apparent from the accompanying drawings and from the detailed description which follows below. The invention will now be elucidated in more detail with reference to certain non-limitative examples of embodiment shown in the attached drawing figures.

### BRIEF DESCRIPTION OF THE DRAWINGS

The present invention is illustrated by way of example and not limitation in the figures of the accompanying drawings, in which like references indicate similar elements, and in which:

FIG. 1 is a cross-sectional view of a first preferred embodiment of the present invention, or invented package.

FIG. 2 is a top view of the cavity side of the invented package of FIG. 1, and shows the package without the MEMS die of FIG. 1.

FIG. 3 is a side view of a lead side of the invented package of FIG. 1.

FIG. 4 is a cross-sectional view of the lead side of the invented package of FIG. 1.

FIG. 5 is a view of the photonic inlet side of the invented package of FIG. 1.

FIG. 6 is a cross-sectional view of a MEMS semiconductor die of FIG. 2.

FIG. 7 is a cross-sectional view of an invented VOA package coupled with the photonic MEMS die of FIG. 1 and two optical fibers.

### DETAILED DESCRIPTION OF A PREFERRED EMBODIMENT

While the description above provides a full and complete disclosure of the preferred embodiments of the present invention, various modifications, alternate constructions, and equivalents will be obvious to those with skill in the art. Thus the scope of the present invention is limited solely by the appended claims.

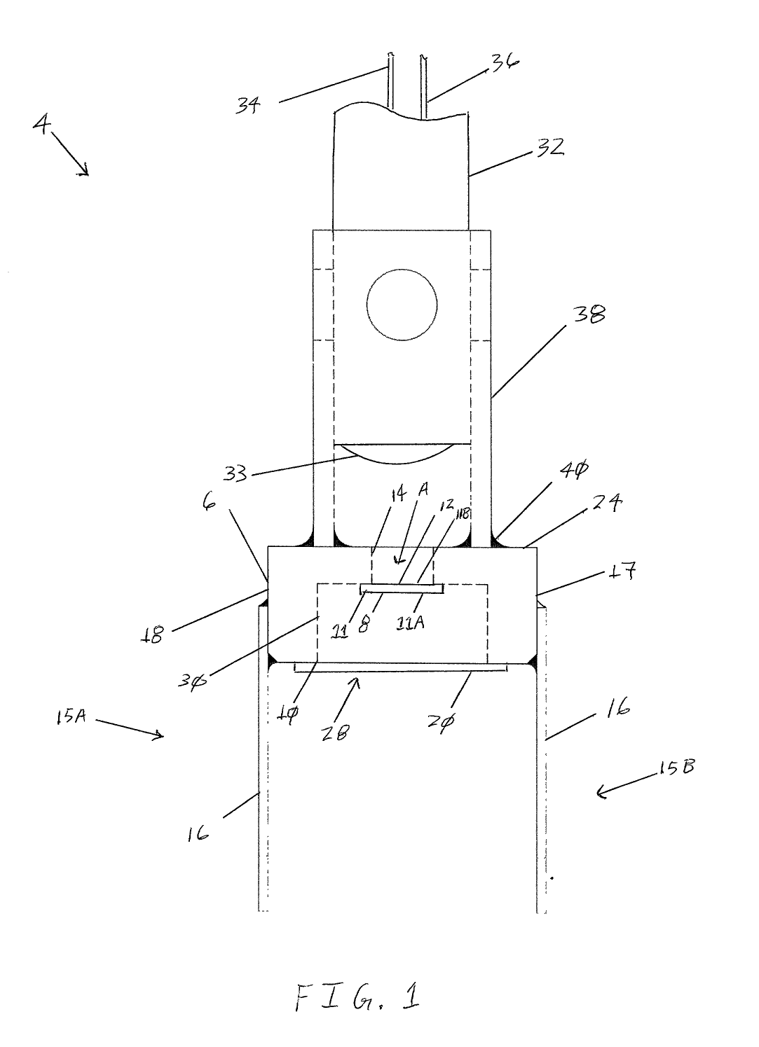

Referring now generally to the Figures and particularly to FIG. 1, FIG. 1 is a cross-sectional view showing a cavity side 2 of a first preferred embodiment of the present invention, or invented package 4. The invented package 4 is a low cost package that comprises a package body 6 designed to house a photonic MEMS semiconductor die 8. The package body 6 may be or comprise a plastic, a ceramic or another suitable material known in the art. More particularly the package body 6 may comprise ALUMINA ceramic. The package body 6 includes the cavity side 2 having a cavity aperture 10. The photonic MEMS semiconductor die 8, or MEMS die 8, comprises a semiconductor substrate 11, or plate 11 having a first side 11A and a second opposite side 11B and a movable mirror 12. The movable mirror 12 is coupled with the second opposite side 11B positioned in line with a through hole 14 to accept all or at least a part of the light passing through the through hole 14 and directed toward an area A of the second opposite side 11B. It is understood that the area A is, in various alternate preferred embodiments of the present invention, a subset of a surface area of the second opposite side 11B or the entire surface area oriented toward the through hole 14. Light is optionally transmitted by reflection from the mirror 12, or generation or emission from the MEMS die 8 and out via the through hole 14, in various preferred embodiments of the present invention. The orientation of the mirror 12 and the through hole 14 allows both the passage of light into the package body 6 and onto the mirror 12, and reflection of light at variable angles from the mirror 12 and through the through hole 14. The mirror 12 is movable and moves in response to power and/or control signals transmitted through a two sets 15A & 15B of a plurality of leads 16 and to the MEMS die 8. The moving or tilting of the mirror 12 controls the angle at which light is reflected from the MEMS die 8. Each set 15A & 15B of leads 16 are mechanically attached to a lead side 17 & 18 of the package body 6 and electrically coupled to the MEMS die 8. The plurality of leads 16 may be or comprise a metal or another suitable electrically conductive material known in the art. More particularly, the leads may comprise KYOCERA ALLOY 42 electrically conductive metal alloy. The plurality leads 16 may be arranged and shaped to meet an industry packaging standard and optionally to fit into a standard or non-standard socket.

A package lid 20 of the invented package 4 substantially covers the cavity aperture 10 and a photonic inlet 22 is attached to a photonic inlet side 24 of the package body 6. The through hole 14 extends from the photonic inlet side 24 and to a base wall 26 of a package cavity 28. The MEMS die 8 is attached to the base wall 26. A cavity side wall 30 extends from the base wall 26 and to the cavity aperture 10.

A collimator 32 is attached to the photonic inlet 22. A lens 33, an optical fiber 34 and an external photonic element 36 are attached to the photonic inlet 22. The lens 33 of the collimator 32 focuses light emitted from one or both the optical fiber 34 and the external photonic element 36 as the light travels from the collimator 32 and to the MEMS die 8. The external photonic element 36 may be or may comprise a photonic element selected from the group consisting of a wave guide, a planar wave guide, a photonic crystal wave guide, a diffraction wave guide grating, an optical fiber, a collimator, a lens, a diffractive lens, an optical lens, a spherical lens, an aspherical lens, a ball lens, a GRIN lens, a C-lens, a lens system, a mirror, a flat mirror, a shaped mirror, a diffractive mirror, a grating plate or plates, a laser, a modulator, a photodiode, a VCSEL, and a prism. Light may be transmitted to and from the optical fiber 34 and the external photonic element 36 in accordance with the optical properties of the optical fiber 34 and the selected external photonic element 36, i.e. certain photonic elements reflect or receive light and not emit or transmit light.

The photonic inlet 22 is located about the through hole 14 in an orientation that enables the transmission of light to and/or from the MEMS die 8 and either or both the optical fiber 34 and external photonic element 36. The photonic inlet 22 is made of KOVAR metal and has layers of metal on an outside surface 38. The layers of material are conducive to brazing the photonic inlet 22 onto the photonic inlet side 24 of the package body 6. The photonic inlet 22 of the invented package 4 has a tungsten layers covered by a Nickel layer, followed by a Gold layer. The Tungsten may be 50 to 150 micro inches thick. The intermediate layer of Nickel may be from 100 to 150 micro inches thick. And the Gold layer may be approximately 60 micro inches thick. The thickness and composition of each metal layer varies in certain alternate preferred embodiments. The photonic inlet 22 is brazed onto the photonic inlet side 24 along a cylindrical through hole end 40.

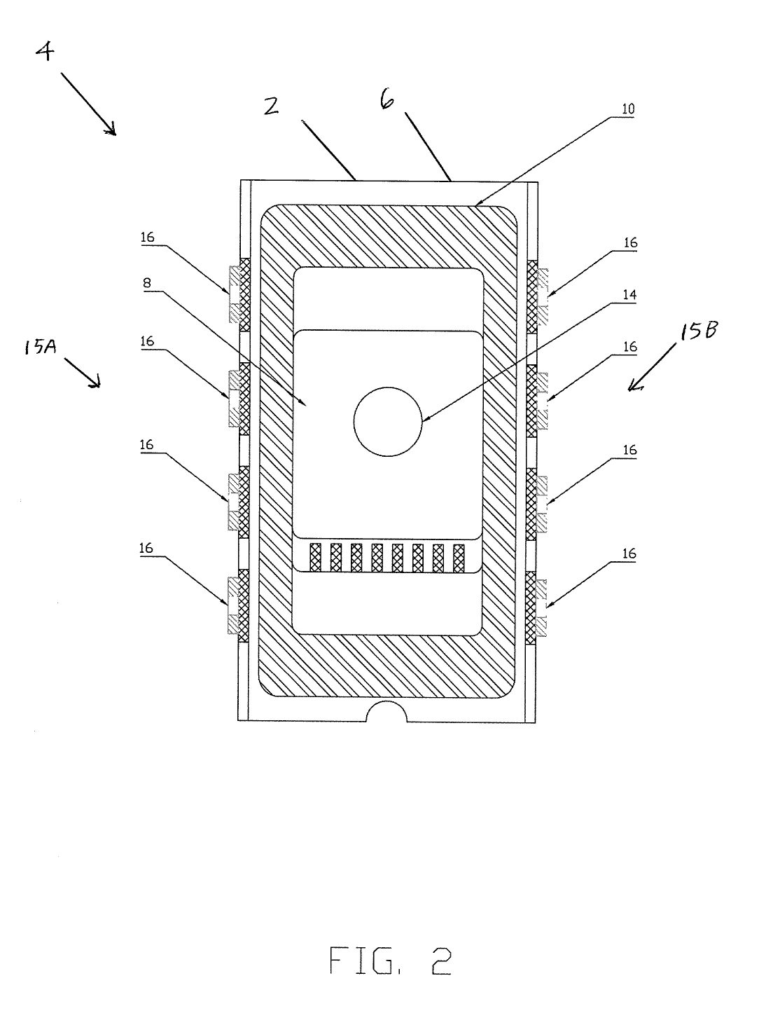

Referring now generally to the Figures and particularly to FIG. 2, FIG. 2 is a top view of the cavity side 2 of the invented package 4 of FIG. 1, and where the MEMS die 8 is not attached to the package body 6. The sets of leads 15A and 15B and the cavity aperture 10 are shown in this top view of FIG. 2.

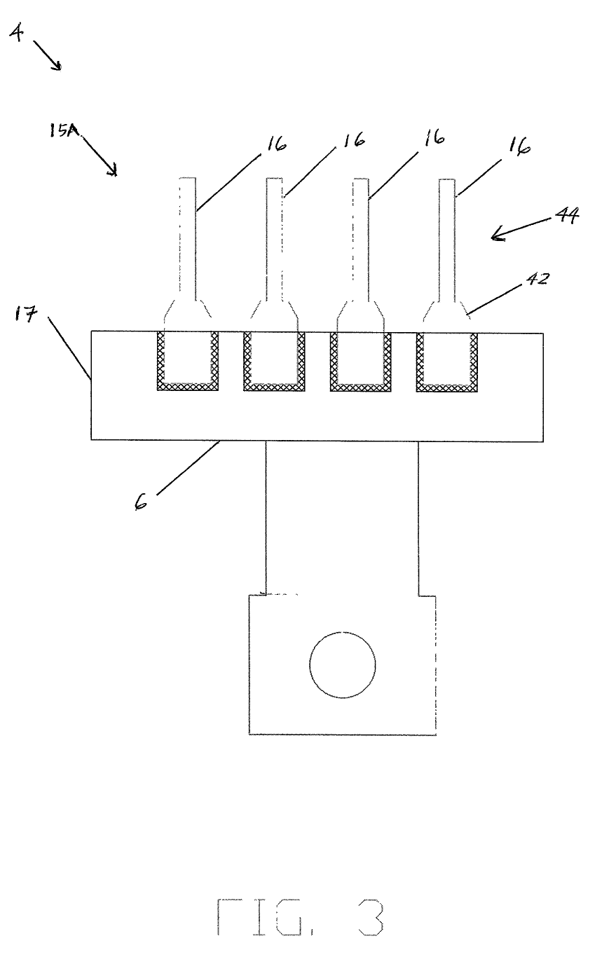

Referring now generally to the Figures and particularly to FIG. 3, FIG. 3 is a side view of the lead side 17 of the invented package 4 of FIG. 1. A lead frame 42 includes the set 15A of leads 16. The set 15A of leads 16 are placed in a first arrangement 44.

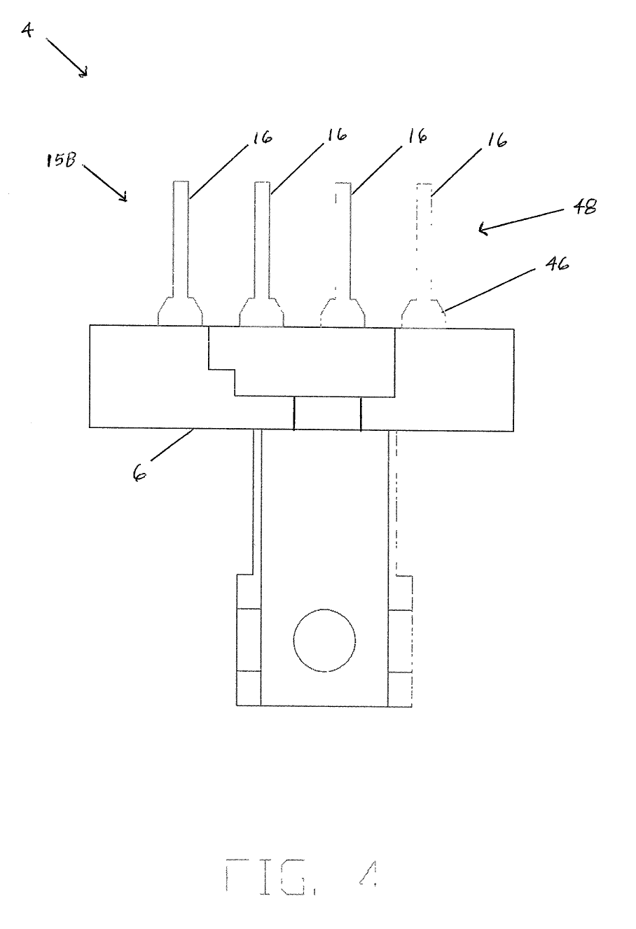

Referring now generally to the Figures and particularly to FIG. 4, FIG. 4 is a cross-sectional view of the invented package 4 of FIG. 1. The set 15B of leads 16 are exposed and shown to be extending from the lead side 18 of the package body 6. The leads 16 of the set 15B are comprised within a lead frame 46. The set 15B of leads 16 are positioned in a second arrangement 48. The second line 48 is parallel to the first line 44 of the set 15A of leads 16.

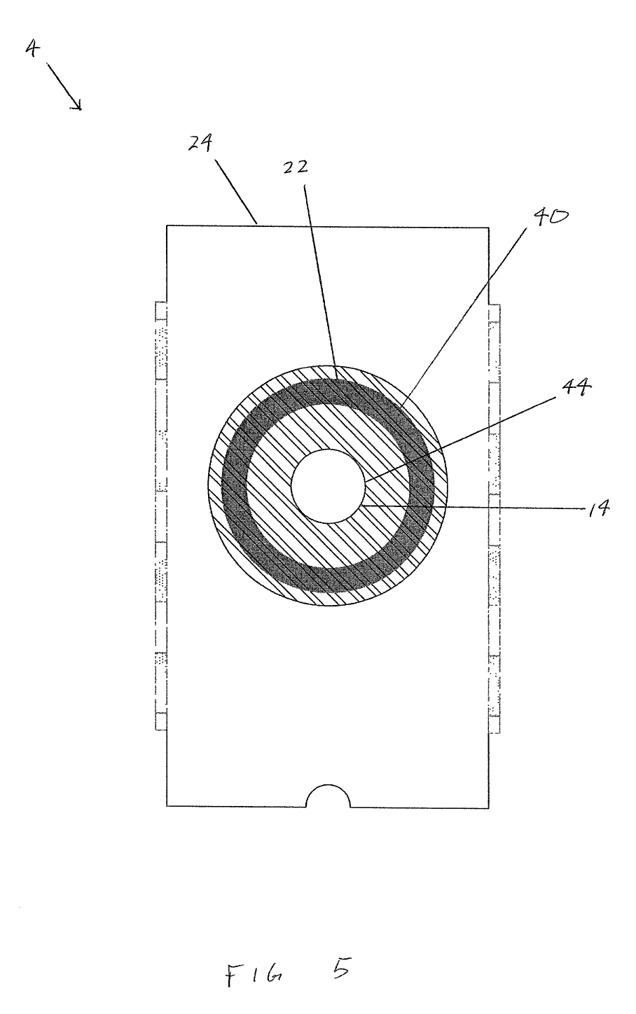

Referring now generally to the Figures and particularly to FIG. 5, FIG. 5 is a view of the photonic inlet side 24 of the invented package 4 of FIG. 1. The photonic inlet 22 is brazed onto the photonic inlet side 24 along the circular through hole end 40. The through hole 14 permits light to travel in and out of the package body 6 and to and from the mirror 12 of the MEMS die 8. The through hole 14 may have an optional transparent shield 44 that protects the MEMS die 8 and does not unacceptably diminish the light transmission into or out of the package body 6.

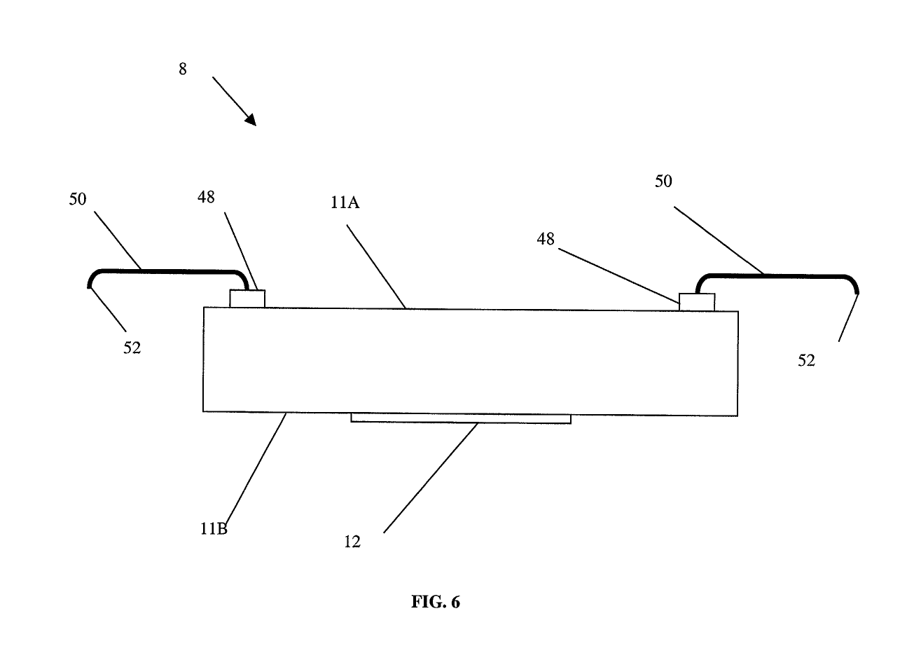

Referring now generally to the Figures and particularly to FIG. 6, FIG. 6 is a cross-sectional view of a MEMS semiconductor die 8 of FIG. 1. The first side 1A of the MEMS die 8 has a plurality of electrical contact pads 48. Each of a plurality of wire bonds 50 are electrically coupled with at least one of the contact pads 48 and with at least one of the leads 16, as shown in of FIG. 1. The electrical coupling of the wire bonds 50 is optionally enabled by a mechanical coupling of each of a plurality of wire bond ends 52 and the package body 6 of FIG. 1. The movable mirror 12 is coupled with the second opposite side 11B of the MEMS die 8. The first side 11A and the second opposite side 11B are substantially planar and parallel. The mirror 12 is controlled by electrical control and power signals sent via the leads 16, the wire bonds 50 and into the MEMS die 8 at the contact pads 48.

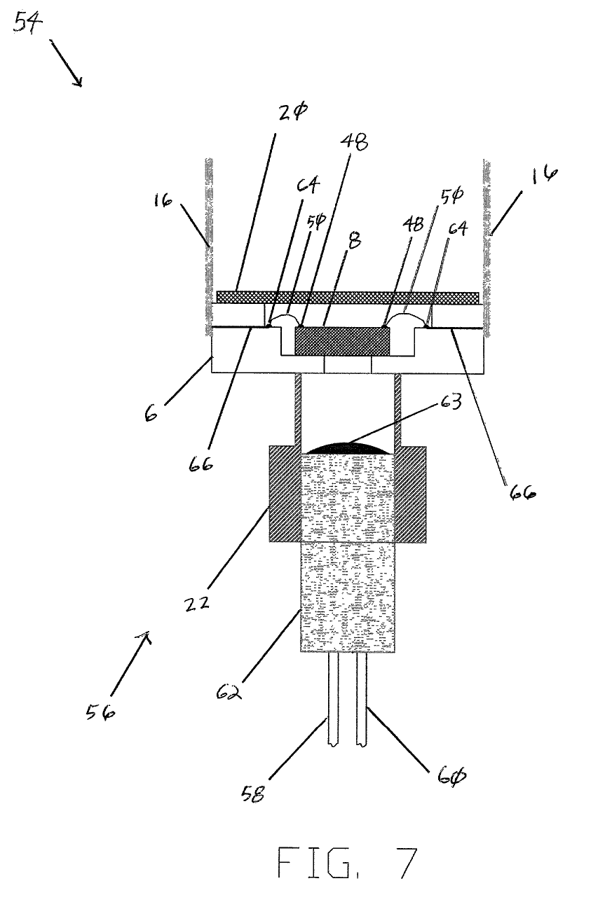

Referring now generally to the Figures and particularly to FIG. 7, FIG. 7 is a cross-sectional view of a photonic component 54 having an invented VOA package 56 coupled with the MEMS 8 die and two optical fibers 58 & 60. The MEMS die 8 is enclosed with in the package body 6 and the lid 20. The two optical fibers 58 & 60 are coupled with the photonic inlet 22 via a dual collimator 62. A lens 63 of the dual collimator 62 focuses light emitted from one or both of the optical fibers 58 & 60 as the light travels from the optical fiber 58 & 60 and to the MEMS die 8. The lid 20 of the invented VOA package 56 seats into the package body 6 and in combination with the package body 6 encloses the MEMS die 8. The lid may be attached to the bonding using suitable standard lid attaching equipment, e.g., lid tacking and lid sealing resistance welding equipment known in the art. The MEMS die 8 is attached to the package body 6 using suitable standard die attach equipment and techniques known in the art. The MEMS die 8 is wire bonded via the wire bonds 50 to wire bond pads 64 located in the package body 6. The wire bonding may use Gold or Aluminum or another suitable wire bonding material known in the art. The wire bonding may be accomplished using a suitable Kulicke and Soffa ball bonder with another suitable standard wire bonding equipment and applying a suitable wire bonding technique known in the art. The wire bond pads 64 are each electrically connected with a trace 66. The traces 66 are additionally electrically connected with the leads 16. Power and control signals are transmitted to the MEMS 8 via the leads 16. These power and control signals enable and direct the movable mirror 12 of the MEMS die 8 to redirect a light beam emitted from one of the optical fibers 58 & 60 to another of the optical fibers 58 & 60. An optical signal delivered to the mirror is thereby controllably attenuated by the process of controlling the position of the movable mirror 12.

The invented VOA package 56 is designed and sized in conformance with one or more standard semiconductor industry materials, sizing and design standards such that the invented VOA package 56 may be formed, fabricated assembled, wire bonded, packaged, tested and attached to the PC board by and of certain semiconductor industry standard materials, equipment and methods. Various preferred embodiments of the package may comprise suitable plastic, metallo-ceramic, or metal-glass, or other suitable materials, known in the art.

The die 8 may be attached to the package body 6 by means of suitable standard die attach equipment and using ABLESTIK adhesive part number 789-3, or another suitable adhesive material or technique known in the art. The wire bonds 50 are formed using standard wire bond equipment, as discussed above. The package 56 is formed and assembled using standard package forming and package assembly equipment. The photonic component 54 and the package 56 are tested using standard electrical, thermal, mechanical and/or other suitable standard test equipment.

Certain alternate preferred embodiments of the method of the present invention can optionally enable the assembly of the invented VOA package 56 that may be assembled with suitable clean room compatible testing and fabrication equipment known in the art. The invented VOA package 56 may be mounted onto a PC board, or a module, a system, a subsystem, or a socket and by using suitable standard device or component mounting equipment and techniques known in the art.

The present invention has been described in conjunction with the preferred embodiments. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense. As noted above, the present invention is applicable to the use, operation, structure and fabrication of a number of different photonic component assemblies. The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications, devices and methods.

1. A photonic component package, the photonic component package enclosing a semiconductor die, the semiconductor die comprising or coupled with a photonic element, and the semiconductor die having a first side with at least two electrical contact pads, and a second opposite side, and the photonic element positioned to transmit or receive light directed toward an area of the second opposite side, the package comprising:
a package body, a lid, and at least two leads;
the package body, or body, having a photonic inlet side, a cavity side, a through hole and a cavity;
the through hole extending from the photonic inlet side and to the cavity, and the through hole for enabling light to pass to and from the semiconductor die;
the lid coupled with the package body and enclosing the cavity; and
whereby the semiconductor die is attached to the package body and within cavity, and each of the at least two leads is electrically coupled with at least one of the at least two electrical contact pads of the semiconductor die, and the area of the second opposite side is positioned to transmit or receive light via the through hole.

2. The photonic component package of claim 1, wherein the photonic component package is a dual inline package and further comprises at least two sets of at least two leads each, and wherein the at least two sets of leads are each arranged in separate and substantially linear and parallel positions relative to another of the at least two sets of leads.

3. The photonic component package of claim 1, wherein the body comprises ceramic.

4. The photonic component package of claim 3, wherein the body comprises alumina.

5. The package of claim 1, wherein the semiconductor die comprises Silicon.

6. The photonic component device package of claim 1, wherein the semiconductor die comprises Gallium Arsenide.

7. The photonic component package of claim 1, wherein the semiconductor die comprises a MEMS device.

8. The photonic component package of claim 7, wherein the MEMS device comprises a mirror, the mirror oriented to reflect light transmitted through the through hole.

9. The photonic component package of claim 1, wherein the package is coupled with a photonic inlet, and the photonic inlet is additionally coupled with a photonic element, the photonic element for emitting light via the through hole and toward the semiconductor die, and the photonic inlet for maintaining an alignment of the photonic element and the semiconductor die.

10. The photonic component package of claim 9, wherein the photonic element is selected from the group consisting of a wave guide, a planar wave guide, a photonic crystal wave guide, a diffraction wave guide grating, an optical fiber, a collimator, a lens, a diffractive lens, an optical lens, a spherical lens, an aspherical lens, a ball lens, a GRIN lens, a C-lens, a lens system, a mirror, a flat mirror, a shaped mirror, a diffractive mirror, a grating plate or plates, a laser, a modulator, a photodiode, a VCSEL, and a prism.

11. The photonic component package of claim 9, wherein the photonic component package is further coupled with a receiving photonic element, the receiving photonic element coupled with the photonic inlet and for receiving light transmitted from the semiconductor die and via the through hole.

12. The photonic component package of claim 11, wherein the receiving photonic element is selected from the group consisting of a wave guide, a planar wave guide, a photonic crystal wave guide, a diffraction wave guide grating, an optical fiber, a collimator, a lens, a diffractive lens, an optical lens, a spherical lens, an aspherical lens, a ball lens, a GRIN lens, a C-lens, a lens system, a mirror, a flat mirror, a shaped mirror, a diffractive mirror, a grating plate or plates, a laser, a modulator, a photodiode, a VCSEL, and a prism.

13. The photonic component package of claim 12, wherein the photonic element is selected from the group consisting of a wave guide, a planar wave guide, a photonic crystal wave guide, a diffraction wave guide grating, an optical fiber, a collimator, a lens, a diffractive lens, an optical lens, a spherical lens, an aspherical lens, a ball lens, a GRIN lens, a C-lens, a lens system, a mirror, a flat mirror, a shaped mirror, a diffractive mirror, a grating plate or plates, a laser, a modulator, a photodiode, a VCSEL, and a prism.

14. The photonic component package of claim 9, wherein the photonic component package is a dual inline package.

15. The photonic component package of claim 9, wherein the body comprises ceramic.

16. The photonic component package of claim 15, wherein the body comprises alumina.

17. The photonic component package of claim 9, wherein the semiconductor die comprises Silicon.

18. The photonic component package of claim 9, wherein the semiconductor die comprises Gallium Arsenide.

19. The photonic component package of claim 9, wherein the semiconductor die comprises a MEMS device.

20. The photonic component package of claim 19, wherein the MEMS device comprises a mirror, the mirror oriented to reflect light transmitted via the through hole.

21. The photonic component package of claim 20, wherein the mirror is movable in response to electrical signals transmitted to the MEMS device via at least one of the at least two leads, whereby the angle of reflection of the light from the MEMS is affected.

22. The photonic component package of claim 1, wherein the at least two leads are oriented to fit into a socket.

23. The photonic component package of claim 1, wherein the at least two leads are positioned to fit into a standard socket.

24. The photonic component package of claim 1, wherein all of the at least two leads are positioned to fit into a socket.

25. The photonic component package of claim 1, wherein the photonic component package is a low cost package.

26. A VOA package, the VOA package enclosing a semiconductor die, the semiconductor die comprising or coupled with a movable mirror, and the semiconductor die having a first side with at least two electrical contact pads and a second opposite side comprising or coupled with the movable mirror, and the package coupled with a collimator, the collimator positioning at least two optical fibers, the package comprising:
a package body, a lid, and at least two leads;
the package body, or body, having a photonic inlet side, a cavity side, a through hole and a cavity;
the through hole extending from the photonic inlet side and to the cavity, and the through hole for enabling light to pass to and from the movable mirror and the at least two optical fibers;
the lid coupled with the body and enclosing the cavity; and
whereby the semiconductor die is attached to the body and within cavity, and the mirror of the semiconductor die is positioned to variably optically attenuate an optical signal emitted from one of the at least two optical fibers through a collimator lens by controllably redirecting the optical signal reflected from the mirror and going back through the collimator lens to another optical fiber.

27. The VOA package of claim 26, wherein the photonic component package is a dual inline package and further comprises at least two sets of at least two leads each, and wherein the at least two sets of leads are each arranged in separate and substantially linear and parallel positions relative to another of the at least two sets of leads.

28. The VOA package of claim 26, wherein the body comprises ceramic.

29. The VOA package of claim 26, wherein the body comprises alumina.

30. The VOA package of claim 26, wherein the semiconductor die comprises Silicon.

31. The VOA package of claim 26, wherein the semiconductor die comprises Gallium Arsenide.

32. The VOA package of claim 26, wherein the semiconductor die comprises a MEMS device.

33. The VOA package of claim 27, wherein the at least two sets of at least two leads are oriented to fit into a socket.

34. The VOA package of claim 27, wherein the at least two sets of at least two leads are positioned to fit into a standard socket.

35. The VOA package of claim 27, wherein all of the at least two sets of at least two leads are positioned to fit into a socket.

36. The VOA package of claim 26, wherein the photonic component package is a low cost package.

37. A method to package a photonic component, comprising:
providing a semiconductor die, the semiconductor die having a photonic element, a first side with at least two electrical contact pads and a second opposite side coupled with the photonic element;
providing a package, the package comprising a package body, a lid, and at least two leads;
the package body, or body, having a photonic inlet side, a cavity side, a through hole and a cavity, and the through hole extending from the photonic inlet side and to the cavity, and the through hole for enabling light to pass to and from the cavity;
die attaching the semiconductor die to the package body and at least partially within cavity, and in an orientation that enables light to pass from the photonic element and out of the package via the through hole; and
coupling the lid with the package body and enclosing the cavity, whereby the semiconductor die is attached to the package body and within the cavity, and each of the at least two leads is electrically coupled with at least one of the at least two electrical contact pads of the semiconductor die, and an area of the second opposite side is positioned to transmit or receive light via the through hole.

38. The method of claim 37, wherein the package is a low cost package.

39. The method of claim 37, wherein standard die attach equipment attaches the semiconductor die to the package body.

40. The method of claim 37, wherein the at least two leads are coupled to the at least two contact pads by wire bonds.

41. The method of claim 40, wherein the wire bonds are formed using standard wire bond equipment.

42. The method of claim 37, wherein the package is assembled with standard packaging equipment.

43. The method of claim 37, wherein the lid is attached to the body package with lid attachment equipment.

44. The method of claim 37, wherein the package is marked with standard semiconductor device marking equipment.

45. The method of claim 37, wherein the photonic component is tested using standard test equipment.

46. The method of claim 37, further comprising providing an electronic module and mounting the device onto the electronic module using standard mounting equipment.

47. The method of claim 37, wherein the package substantially complies with a suitable package standard known in the art.
